(19) United States
(12) Patent Application Publication
(10) Pub. No.: US 2021/0056428 A1
(43) Pub. Date: Feb. 25, 2021

(54) De-Biasing Graph Embeddings via Metadata-Orthogonal Training

(71) Applicant: Google LLC, Mountain View, CA (US)

(72) Inventor: John Joseph Palowitch, San Francisco, CA (US)

(21) Appl. No.: 17/000,732

(22) Filed: Aug. 24, 2020

Related U.S. Application Data
(60) Provisional application No. 62/890,322, filed on Aug. 22, 2019.

(51) Int. Cl. G06N 3/08; G06F 17/16

(52) U.S. Cl. CPC G06N 3/084; G06F 17/16

(57) ABSTRACT

The present disclosure provides a neural graph embedding approach that embeds topology and metadata information in separate metric spaces. In particular, even using models with explicit metadata embeddings, topology embeddings become correlated with the metadata when the metadata are related to the graph structure. To prevent this information leakage, the present disclosure introduces a Metadata-Orthogonal Node Embedding Training (MONET) unit, which trains the topology embeddings on a hyperplane orthogonal to the metadata embeddings.

### RELATED APPLICATIONS

This application claims priority to and the benefit of U.S. Provisional Patent Application No. 62/890,322, filed Aug. 22, 2020, which is hereby incorporated herein by reference in its entirety.

### FIELD

The present disclosure relates generally to processing of graphs. More particularly, the present disclosure relates to techniques to de-bias graph embeddings produced for a graph by a graph neural network via performance of metadata-orthogonal training.

### BACKGROUND

Graph embeddings—continuous, low-dimensional vector representations of nodes of a graph—have been eminently useful in network visualization, node classification, link prediction, and many other graph learning tasks. Distances in embedding space preserve graph features like node neighborhoods and path distances, effectively ignoring spurious edges. Graph embeddings can be estimated directly by unsupervised algorithms or trained in semi-supervised models.

Often, ample node metadata—e.g., demographics, geo-spatial, attribute or feature values, or text—are available with the graph under study and are sometimes measurably related to the graph topology. Thus, metadata can enhance graph learning models, and conversely, graphs can be used as regularizers in supervised and semi-supervised models of node features. Furthermore, metadata are commonly used as evaluation data for graph embeddings. In one example, node embeddings trained on a user graph from an image sharing platform were shown to predict user-specified “interests.” This is presumably because users (e.g., represented as nodes) in the corresponding graph tend to follow users with similar interests, which illustrates a potential causal connection between node topology and node metadata.

Though graphs are inherently high-dimensional and noisy, graph representations (e.g., embeddings, stochastic models, etc.) are by design small and concise. Therefore, as metadata can be associated with graph structure, substantial subspaces of estimated graph representations can be confounded with external factors. For instance, in many real world graphs, the formation of node neighborhoods is correlated with (or even caused by) certain metadata (e.g. user interests, demographics, reputation, associated text, etc.). In this case, any graph neural network will be biased by this information, as it is encoded in the structure of the adjacency matrix itself. In particular, example experiments have shown that when metadata is correlated with the formation of node neighborhoods, unsupervised node embedding dimensions learn this metadata (even when the model incorporates metadata directly). This bias implies an inability to control for important covariates in applications, and that when metadata weights are specified in the embedding neural network, they suffer information leakage into other parameters.

While many graph learning models incorporate metadata, standard approaches in this space are geared toward text, and enforce metric similarity between the metadata and topology embeddings. Techniques for representing and separating out the statistical effect of arbitrary metadata, and the information trade-off between node metadata representations and node topology representations, have yet to be explored in the neural network setting.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to de-bias a graph neural network. The method includes obtaining, by one or more computing devices, a graph that comprises a plurality of nodes and a metadata matrix that contains a respective set of metadata for each of the plurality of nodes. The method includes defining, by the by the one or more computing devices, a topology embedding matrix that contains a plurality of topology embeddings respectively associated with the plurality of nodes. The method includes defining, by the one or more computing devices, a metadata embedding matrix that contains a plurality of metadata embeddings respectively associated with the plurality of nodes, wherein the metadata embedding matrix comprises the metadata matrix multiplied by a metadata transformation. The method includes, for each of one or more training iterations: determining, by the one or more computing devices, an orthogonal topology embedding matrix that comprises the topology embedding matrix projected onto a hyperplane that is orthogonal to the metadata embedding matrix. The method includes, for each of the one or more training iterations: generating, by the one or more computing devices, an output based on one or both of the orthogonal topology embedding matrix and the metadata transformation. The method includes, for each of the one or more training iterations: determining, by the one or more computing devices, a topology embedding update to the topology embedding matrix based at least in part on a loss function that evaluates the output. The method includes, for each of the one or more training iterations: projecting, by the one or more computing devices, the topology embedding update onto the hyperplane that is orthogonal to the metadata embedding matrix to obtain an orthogonal topology embedding update. The method includes, for each of the one or more training iterations: updating, by the one or more computing devices, the orthogonal topology embedding matrix according to the orthogonal topology embedding update.

Another example aspect of the present disclosure is directed to a computing system that includes a graph neural network trained according to any of the methods described herein, one or more processors, and one or more non-transitory computer-readable media that collectively store instructions that, when executed by one or more computing devices, cause the one or more computing devices to run the graph neural network to generate a set of additional embeddings for an additional graph.

Another example aspect of the present disclosure is directed to one or more non-transitory computer-readable media that collectively store instructions that, when executed by one or more computing devices, cause the one or more computing devices to perform operations. The operations include obtaining a graph that comprises a plurality of nodes and a respective set of metadata for each of the plurality of nodes. The operations include defining a plurality of topology embeddings respectively associated with the plurality of nodes. The operations include defining a plurality of metadata embeddings respectively associated with the plurality of nodes, wherein the plurality of metadata embeddings comprises the respective sets of metadata multiplied by a metadata transformation. The operations include, for each of one or more training iterations: determining a plurality of orthogonal topology embeddings that comprises the plurality of topology embeddings projected onto a hyperplane that is orthogonal to the plurality of metadata embeddings; generating an output using one or both of the plurality of orthogonal topology embeddings and the metadata transformation; determining a plurality of topology embedding updates to the plurality of topology embeddings based at least in part on a loss function that evaluates the output; projecting the plurality of topology embedding updates onto the hyperplane that is orthogonal to the plurality of metadata embeddings to obtain a plurality of orthogonal topology embedding updates; and updating the plurality of orthogonal topology embeddings according to the plurality of orthogonal topology embedding updates.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graph diagram of an example Z-orthogonal training of parameters W according to example embodiments of the present disclosure.

FIG. 2 depicts a block diagram of an example MONET unit for input-output graph embedders according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

FIGS. 4A and 4B depict a flow chart diagram of an example method to train a graph neural network according to example embodiments of the present disclosure.

Reference numerals that are repeated across plural figures are intended to identify the same features in various implementations.

### DETAILED DESCRIPTION

### Overview

Generally, the present disclosure is directed to a new neural graph embedding approach that embeds topology and metadata information in separate metric spaces. In particular, as described above, even using models with explicit metadata embeddings, topology embeddings become correlated with the metadata when the metadata are related to the graph structure. To prevent this information leakage, the present disclosure introduces a Metadata-Orthogonal Node Embedding Training (MONET) unit, which trains the topology embeddings on a hyperplane orthogonal to the metadata embeddings.

More particularly, most unsupervised models (as well as some semi-supervised models) for graph neural networks are trained on sequences of random walks on the graph. By node proximity, random walks encode neighborhood information. It is these proximities, or “co-occurrences” as they are called in the literature, that are shown to graph neural networks in batches, as training examples. The number of co-occurrences in a sequence of random walks is a rough proxy for the similarity between two nodes. Graph embedding networks try to learn these similarities by approximating the high-dimensional co-occurrence counts with dot products in a low-dimensional embedding space.

Roughly, in certain existing approaches, a graph embedding matrix W attempts the following approximation:

Wᵢ^{T}Wⱼ˜f(Cᵢⱼ)

where Cᵢⱼ is the co-occurrence count, f( ) is some useful transformation (e.g., a logarithm or log), and Wᵢ is the i-th row of the embedding matrix.

The present disclosure proposes that, because graph metadata influence neighborhood formation in graphs (e.g., consider that online community membership, personal interests, demographics, or text data could all predict links in social graphs), dot products in a certain metadata embedding space could be useful in the above co-occurrence count approximation.

Thus, according a first aspect, the present disclosure provides a novel way to jointly but separately model both topological node embeddings and metadata embeddings. In particular, given a matrix of metadata M, the present disclosure proposes the learning of a metadata embedding matrix Z=MT, with T a trainable transformation, via the additive model

Wᵢ^{T}Wⱼ+Zᵢ^{T}Zⱼ˜f(Cᵢⱼ)

This particular extension to unsupervised graph embedding models allows for the encoding of arbitrary metadata types, and stands in contrast to previous work that enforces W and Z to have the same column dimension.

While the above model stands as a contribution to unsupervised graph neural networks, it does not fully solve the problem of dividing embedding space into informationally-separate graph topology and graph metadata components.

In particular, in some implementations, even though the embeddings Z are incorporated explicitly to learn metadata effect on co-occurrences, the metadata-decorrelated embeddings W can still “learn” the metadata effect due to properties of neural network backpropagation. This effect can be referred to as “metadata information leakage”, and results in embeddings W and Z that duplicate information and therefore do not efficiently and parsimoniously divide metadata effects from other latent factors.

To resolve these metadata leakage issues, aspects of the present disclosure are directed to a Metadata-Orthogonal Node Embedding Training (MONET) unit, which learns the directions of metadata effect on node neighborhood formation and concurrently trains separate embedding dimensions on a hyperplane orthogonal to those directions. The MONET unit is a powerful technique for organizing unstructured embedding dimensions into an interpretable topology-only division and metadata-only division.

In some implementations, the MONET unit uses Singular Value Decomposition—a mathematical tool to decompose a matrix into linearly independent components—to construct a metadata embedding orthogonal hyperplane. In particular, in some implementations, at each training step: the embeddings W are projected onto a Z-orthogonal hyperplane; the backpropagation updates to W are also projected onto the Z-orthogonal hyperplane; and the hyperplane is recomputed after backpropagation updates to Z.

To illustrate the effectiveness of the proposed method, an example implementation of the MONET unit was incorporated into an unsupervised model for graph embedding. Example experiments performed on a variety of real world graphs show that the example MONET unit can learn and remove the effect of covariates, preventing the leakage of political party affiliation in a blog network, and thwarting the gaming of embedding-based recommendation systems. U.S. Provisional Patent Application No. 62/890,322, which is incorporated into and forms a portion of this disclosure, includes analysis which proves that naive graph neural networks with metadata parameters nonetheless leak metadata information, and that the proposed MONET unit does not. U.S. Provisional Patent Application No. 62/890,322 also contains data and description of the example experimental results on real world graphs which show that MONET can successfully “de-bias” topology embeddings while relegating metadata information to separate metadata embeddings.

Thus, the present disclosure demonstrates that unsupervised training of graph embeddings induces bias from important graph metadata. However, the present disclosure also proposes a solution to address this problem—the MONET unit. The MONET unit is a graph learning technique for training-time de-biasing of embeddings, using orthogonalization. The example experimental results using real datasets show that MONET is able to encode the effect of graph metadata in isolated embedding dimensions (while simultaneously removing the effect from other dimensions).

The proposed techniques have immediate practical applications and various technical effects and benefits. In particular, by learning the graph topology embeddings orthogonal to the metadata embeddings, the proposed techniques are able to de-bias the graph topology embeddings (that is, remove the leakage of metadata into the graph topology embeddings). In such fashion, new, metadata-decorrelated graph topology embeddings can be obtained which may reveal additional information about or relationships between nodes which are decorrelated from the metadata, which were heretofore unrealizable due to leakage of metadata information.

Similarly, by learning the metadata embeddings orthogonal to the graph topology embeddings, the proposed techniques are able to generate a superior embedding of the metadata which is better able to capture complex metadata in a topologically-decorrelated fashion. Thus, new, topologically-decorrelated metadata relationships may be discoverable.

In such fashion, the present disclosure can provide improved forms of graph embeddings (whether topological or metadata). Graph embeddings are eminently useful in network visualization, node classification, link prediction, and many other graph learning tasks. Thus, by improving the underlying embeddings, the performance of a system that performs network visualization, node classification, link prediction, and/or many other graph learning tasks can also be improved. This may enable improved services to be provided to a user, such as improved matching of users with desired resources (e.g., web pages, social network connections, media content items, etc.). By providing improved matching of users with desired resources at a first instance, the performance of additional instances of matching can be avoided, thereby conserving computing resources such as processor usage, memory usage, and network bandwidth usage.

Aspects of the present disclosure introduce the basic principles underlying the need for the MONET technique, and show its utility in a shallow graph neural network (e.g., GloVe, described below). However, although a shallow network is used for instructional purposes and to enable simplified and clear explanation, the concepts embodied in the MONET unit are highly generalizable. MONET units can be used to de-bias any set of embeddings from another set during training. MONET can be used in deeper networks and semi-supervised models or graph convolutional networks. Because word embeddings are trained on word co-occurrences in a similar fashion to node embeddings, MONET can be applied to standard word embedding techniques to de-bias word embeddings during training.

Further, although certain example implementations of MONET rely upon performance of SVD calculation, alternative implementations can employ SVD approximations, or training algorithms that utilize caching of previous metadata embedding SVDs to speed up training.

A number of use cases or applications exist for the techniques described herein. For example, the nodes of the graph can correspond to any different entity, person, organization, object, location, biological or pharmaceutical component, text string, image, concept, and/or various other items. The graph can map known relationships or structures between such items while the graph metadata can include any data about different attributes, characteristics, and/or various other information about the items represented by the nodes. As described above, the techniques described herein can be used to generate improved and decorrelated topology embeddings and/or metadata embeddings. These improved embeddings can be used to perform a topology-decorrelated and/or metadata-decorrelated similarity search for items (e.g., to discover new items that are similar to a base item as evidenced by similarity between their metadata embeddings and/or their topology embeddings). For example, similarity between embeddings can be measured by an L2 distance, Euclidian distance, or similar measure of distance between the embeddings.

As one specific example application, the nodes in the graph can correspond to biological structures such as proteins or genetic sequences and the metadata can correspond to attributes or other information about the structures such as locations within the body at which such structures are expressed, physical structure (e.g., fold structure), structure functionality, chemical behavior, clinical usages, known maladies or characteristics associated with such structures, and/or the like. The edges between the nodes can correspond to any known relationships such as, for example, experiment-based interactions, shared properties or classifications, shared clinical usages, shared or related mentions in literature, biological relationships (e.g., excitatory, inhibitor, blocking, etc.), and/or the like. Automated protein or genetic sequence discovery can be performed using the resulting metadata and/or topology embeddings.

As another example application, the nodes in the graph can correspond to chemical structures such as pharmaceutical compounds or molecules and the metadata can correspond to attributes or other information about the molecules such as chemical behavior/interactions, chemical structure, clinical usages, physical properties, group functionality, known receptor sites, known side effects or characteristics associated with such structures, and/or the like. The edges between the nodes can correspond to any known relationships such as, for example, experiment-based interactions, shared properties or classifications, shared clinical usages, shared or related mentions in literature, chemical relationships (e.g., neutralizing, amplifying, etc.), and/or the like. Automated drug discovery can be performed using the resulting metadata and/or topology embeddings. Thus, one example use case includes performing drug discovery via embedding compounds from their experiment-based interactions, with compound features as metadata. Another example use case includes performing drug discovery via embedding compounds from their mentions in the literature, with article/journal features as metadata.

An additional example application includes generating embeddings for graphs that model joint interactions in robotics. Yet another example application includes generating embeddings for computational graphs and graph compilers.

### Example Notation

An n-node graph is denoted by G=(N, A) where N={u₁, . . . , uₙ} is the node set and A is the adjacency matrix. A d-dimensional graph embedding is a matrix Wϵ [symbol] ^{n×d} which aims to preserve low-dimensional structure (d<<n). Rows of W correspond to nodes, and node pairs i, j with large dot-products Wᵢ^{T}Wⱼ should be structurally or topologically close in the graph. Certain recent neural embedding techniques relevant to the present disclosure are described below.

Example Graph Embeddings from Random Walks

Example implementations of the present disclosure use graph neural networks trained on random walks, similarly to DeepWalk as introduced in Perozzi et al. Deepwalk: Online learning of social representations. In Proceedings of the 20th ACM SIGKDD international conference on Knowledge discovery and data mining, pages 701-710. ACM, 2014.

DeepWalk and many subsequent methods first generate a sequence of random walks from the graph, and then train graph embeddings using the Skip-Gram objective (Mikolov et al. Efficient estimation of word representations in vector space. arXiv preprint arXiv:1301.3781, 2013), using the random walks as input. This approach essentially treats the random walks like a “corpus” of node “sentences” and applies word embedding techniques like word2vec (Mikolov et al., Distributed representations of words and phrases and their compositionality. In Advances in neural information processing systems, pages 3111-3119, 2013).

Recently, Brochier et al. (Global vectors for node representations. arXiv preprint arXiv:1902.11004, 2019) explored graph embedding with the GloVe model (Pennington et al. Glove: Global vectors for word representation. In Proceedings of the 2014 conference on empirical methods in natural language processing (EMNLP), pages 1532-1543, 2014), which is similar to word2vec. Applied to graphs, GloVe is a nodal log-bilinear model of random walk co-occurrence counts. Given a sequence of L-length random walks S and an integer window size w>0, the first step in the GloVe algorithm is to compute the weighted co-occurrence matrix C, where

$${C}_{ij} = {\sum }_{s ∈ S} {\sum }_{k , l \leq L} 1 ( s ( k ) = {u}_{i} ) 1 ( s ( l ) = {u}_{j} ) 1 ( \vert k - l \vert \leq w ) / \vert k - l \vert . \qquad ( 1 )$$

Simply, Cᵢⱼ is the number of times node uⱼ appears in the w-context of node uᵢ in the random walks S, with each count weighted by the walk distance. Given the weighted co-occurrences C, center and context weights U,Vϵ [symbol] ^{n×d}, and biases a, bϵ [symbol] ^{n×1}, the GloVe training objective is

$$ℒ ( U , V , a , b \vert C ) = {\sum }_{i , j \leq n} {f}_{α} ( {C}_{ij} ) {( {a}_{i} + {b}_{j} + {U}_{i}^{T} {V}_{j} - log ( {C}_{ij} ) )}^{2} \qquad ( 2 )$$

where f_{α} is the loss smoothing function from (Pennington et al.). The bias parameters a and b capture inherent frequencies of center and context nodes, respectively, while U and V encode center-context node similarity. [symbol] can be optimized with Stochastic Gradient Descent, during which row vectors of U and V are moved closer/farther apart when their corresponding nodes occur in each other's contexts more/less frequently.

The GloVe model is used throughout the present disclosure to demonstrate topology/metadata embeddings and metadata-orthogonal training. However, the proposed MONET unit is broadly generalizable.

Example Embedding Arbitrary Metadata in Co-Occurrence Models

A useful perspective on GloVe is that embeddings U and V are trained so that distances U^{T}V predict or “account for” the variance in log (C), beyond baselines a, b. This allows GloVe embeddings to encode node neighborhood information—node pairs (i,j) frequently appearing in nearby in random walks will tend to have larger dot products Uᵢ^{T}Vⱼ. U and V are referred to herein as “topology” embeddings.

Here it is assumed that, along with the graph G, we have access to arbitrary n×m metadata matrix M, where row vector Mᵢ is the metadata for node uᵢ. If certain metadata (columns of M) could plausibly associate with or influence neighborhood formation—like online community demographics, or text content—then the distances M^{T}M could also account for co-occurrence variance in the embedding model. As one example, Mᵢ^{T}Mⱼ could be the count of shared interests between uᵢ and uⱼ, which should affect the likelihood uᵢ or uⱼ follow the other.

However, the magnitude and direction of the effect of M is in general unknown—especially when M contains metadata of heterogeneous types—and can easily vary across many instances of similar networks. Thus, the present disclosure proposes training a metadata transformation Tϵ [symbol] ^{m×d}^{₁} where d₁≤m is the desired representation dimension for the metadata effect on co-occurrences. This produces a “metadata embedding” matrix Z=MT, encoding the statistical effect of metadata on neighborhood formation. Throughout, for the sake of simplicity, a GloVe model is used with metadata embeddings X:=MT₁, Y:=MT₂ called GloVeₘₑₜₐ:

$${ℒ}_{meta} ( U , V , {T}_{1} , {T}_{2} , a , b \vert C , M ) = \frac{1}{2} {\sum }_{i , j \leq n} {f}_{α} ( {C}_{ij} ) {( {a}_{i} + {b}_{j} + {U}_{i}^{T} {V}_{j} + {X}_{i}^{T} {y}_{j} - log ( {C}_{i j} ) )}^{2} . \qquad ( 3 )$$

### Metadata Information Leakage and Example Orthogonal Training

One of the contributions provided herein is a method to achieve a parsimonious topology-metadata division of graph embedding space, with respect to given metadata. Though the naïve loss ( [symbol] ₘₑₜₐ) proposed in Eq (3) incorporates a separate metadata embedding term, this section proves that, under certain conditions, the topology embeddings can still learn metadata information. Simply put, if the metadata are associated with the co-occurrence distribution, standard backpropagation techniques will leak metadata information into the topology embeddings. Motivated by this result, a proposed technique prevents this by orthogonalizing topology embeddings against metadata embeddings during training. This implies independence with the metadata.

Example Metadata Leakage in Graph Neural Networks

To make the leakage claims explicit, the present disclosure adopts a generative perspective on the co-occurrence counts C. For metadata Mϵ [symbol] ^{n×m} and a “ground-truth” transformation Bϵ [symbol] ^{m×d}^{_{B}}, define ground-truth metadata embeddings \tilde{Z}:=MB, which will represent the “true” dimensions of the metadata effect on C. For simplicity in assessing the GloVeₘₑₜₐ model, without loss of generality, we disregard loss weighting, and use a center-context symmetric loss with W:=U=Vϵ [symbol] ^{n×d} as the sole topology embedding and T:=T₁=T₂ϵR^{m×d}^{_{z}} as the sole metadata transformation parameter:

$${\tilde{L}}_{meta} ( W , T , a \vert C , M ) = \frac{1}{2} {\sum }_{i , j \leq n} {( {a}_{i} + {a}_{j} + {W}_{i}^{T} {W}_{j} + {Z}_{i}^{T} {Z}_{j} - log ( {C}_{ij} ) )}^{2} \qquad ( 4 )$$

Define Σ_{B}:=BB^{T} and E_{T}:=TT^{T}. With expectations taken with respect to the sampling of a pair (i,j) for Stochastic Gradient Descent, define μ_{W}:= [symbol] Wᵢ and Σ_{W}:= [symbol] WᵢWᵢ^{T}. Define μ_{M}, Σ_{M} similarly. With δ_{W}^{(ij)} as the Stochastic Gradient Descent update W′←W+δ_{W}^{(ij)}, we state the Theorem:

Theorem 1: Assume Σ_{W}=σ_{W}I_{d} for σ_{W}>0, μ_{W}=0_{d}, and μ_{M}=0_{d}_{_{M}}. Suppose for some fixed θϵ [symbol] we have log(Cᵢⱼ)=θ+\tilde{Z}ᵢ^{T}\tilde{Z}ⱼ. Then if [symbol] MᵢXᵢ^{T}=β for some βϵ [symbol] ^{d}^{_{B}}^{×d} such that ∥β∥_{F}²>0, we have

[symbol]

M^{T}δ_{W}^{(ij)=}2[Σ_{M}(Σ_{B}−Σ_{T})−σ_{W}I_{d}_{_{M}}]β. (5)

Theorem 1 implies that, if the matrix Σ_{M}(Σ_{B}−Σ_{T})−σ_{W}I_{d}_{_{M}} is positive-definite, the next Stochastic Gradient Descent updates will increase (in expectation) the magnitude of the current metadata-topology embedding covariance β. We sketch a simple example. Consider one-dimensional metadata consisting of a perfect split of 1.0 and −1.0 values—perhaps an online community indicator. Suppose θ=1.0 and B=[1.0], so that nodes with identical metadata values have log-co-occurrence 2.0, and log-cooccurrence 0.0 otherwise—this is co-occurrence association with community. If Σ_{T}=σ_{T}=σ_{W}=0.1, as model parameter initialization scales, then Theorem 1 implies [symbol] Mδ_{W}^{(ij)}=1.6β.

Note the probability of the assumption ∥β∥_{F}²>0 is equal to 1 under reasonable parameter initialization schemes. This essentially means that topology embeddings and metadata will have some correlation on initialization, and Theorem 1 says that when graph neighborhoods are associated with the metadata, that correlation will increase in magnitude. Also, in practice Σ_{W} may not be perfectly diagonal and μ_{W} only approximately zero, but these only add small order terms to the derivation.

Proof. Derivatives of [symbol] ₘₑₜₐ yield that the i-th row of δ_{W}^{(ij)} is dᵢⱼWⱼ^{T}, where

$${d}_{ij} = log ( {C}_{ij} ) - {Z}_{i}^{T} {Z}_{j} - {W}_{i}^{T} {W}_{j} - {a}_{i} - {a}_{j} = θ + {\tilde{Z}}_{i}^{T} {\tilde{Z}}_{j}^{T} - {Z}_{i}^{T} {Z}_{j} - {W}_{i}^{T} {W}_{j} - {a}_{i} - {a}_{j} . \qquad ( 6 )$$

Similarly the j-th row is dᵢⱼWᵢ^{T}, and all other rows are zero vectors. Hence

[symbol]

M^{T}δ_{W}^{(ij)}= [symbol] MᵢdᵢⱼWⱼ^{T}+ [symbol] MⱼdᵢⱼWᵢ^{T}. (7)

Derive the first term on the right-hand side of Equation (7). [symbol] Mⱼ(θ−aᵢ−bⱼ)Wᵢ^{T}=0 by independence and centering assumptions. [symbol] MⱼWⱼWᵢ^{T}Wᵢ=βσ_{W}I_{d}=σ_{W}I_{d}_{_{M}}β by independence. [symbol] MⱼZⱼ^{T}ZᵢWᵢ^{T}= [symbol] MⱼMⱼ^{T}BB^{T}MᵢWᵢ^{T}=Σ_{M}(Σ_{B})β by independence and scaling, and similarly [symbol] Mⱼ\tilde{Z}ⱼ^{T}\tilde{Z}ᵢWᵢ^{T}=Σ_{M} (Σ_{T})β by independence. Combining these with Equation 6, we have

[symbol]

MᵢdᵢⱼWⱼ^{T}=[Σ_{M}(Σ_{B}−Σ_{T})−σ_{W}I_{d}_{_{M}}]β. (8)

By symmetry, [symbol] MⱼdᵢⱼWⱼ^{T}= [symbol] MᵢdᵢⱼWⱼ^{T}, which with Equation 7 completes the proof.

Example Metadata-Orthogonal Node Embedding Training (MONET)

As Z=MT, Theorem 1 implies that under certain conditions, topology embedding dimensions W will become correlated with metadata embeddings Z. To prevent this, the present disclosure introduces the Metadata-Orthogonal Node Embedding Training (MONET) unit, which uses the Singular Value Decomposition (SVD) of Z to orthogonalize updates to W during training.

Specifically, given a metadata embedding Zϵ [symbol] ^{n×d}^{_{z}} with d_{z}<n, let Q_{Z} be the left-singular vectors of Z, and define the projection P_{Z}:=I_{n×n}−Q_{Z}Q_{Z}^{T}. Given general neural network layer weights H, an example MONET unit training algorithm is presented in Algorithm 1. Note that P_{Z} is not trainable and is not a node in the computation graph for backpropagation.

Example Algorithm 1: MONET Unit Training Step

Given: topology embedding W, metadata embedding Z=MT, transformation H:

### 1: Procedure Forward Pass(W, Z, H)

2: Compute orthogonal topology embedding W^{⊥}=P_{Z}W
3: Compute next layer [W^{⊥},Z]^{T}H
4. Procedure Backward Pass(δ_{W}, δ_{T})
5. Compute orthogonal topology embedding update δ_{W}^{⊥}=P_{Z}δ_{W}
6. Apply updates T←T+δ_{T}, W^{⊥}←W^{⊥}+δ_{W}^{⊥},

By straightforward properties of the SVD, we have the following Theorem giving orthogonal training:

Theorem 2: Using Algorithm 1, Z^{T}W^{⊥}=0_{d}_{_{z}}_{,d} and Z^{T}δ_{W}^{⊥}=0_{d}_{_{z}}_{,d}.

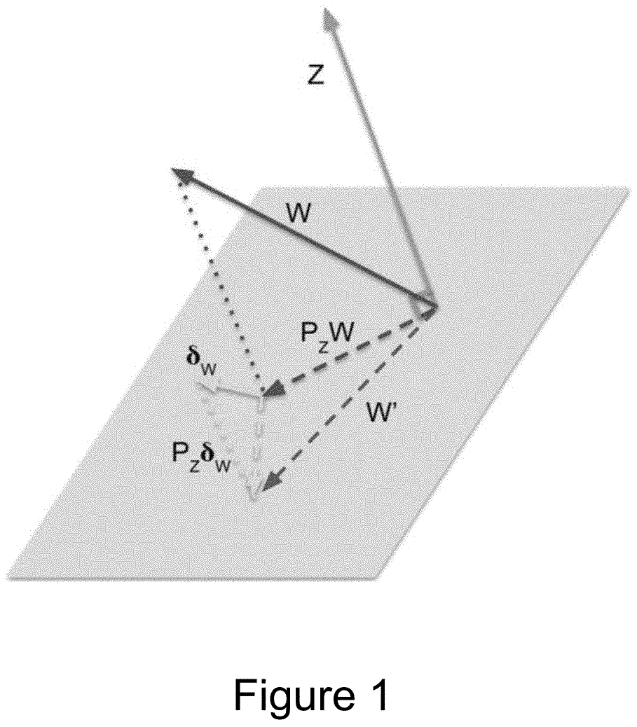

Example Geometric Interpretation: As illustrated in FIG. 1, both prediction with and training of W occur on a hyperplane orthogonal to Z. During the forward pass, W is projected onto the Z-orthogonal plane. When a candidate update δ_{W} is proposed, it too is mapped on to the orthogonal plane, resulting in the best metadata-orthogonal update. This allows W to efficiently explore the space of unknown latent structure without any information leakage from Z.

Algorithmic Complexity: The bottleneck of MONET occurs in the SVD computation and orthogonalization. In the proposed setting, the SVD is O(nd_{z}²). The matrix P_{Z} need not be computed to perform orthogonalization steps, as P_{Z}W=W−Q_{Z}(Q_{Z}^{T}W), and the right-hand quantity is O(ndd_{z}) to compute. Hence the general complexity of the MONET unit is O(nd_{z} max{d, d_{z}})

Example MONET (GloVeₘₑₜₐ)

Example experiments contained in U.S. Provisional Patent Application No. 62/890,322 analyze the effect of MONET by installing it in the GloVeₘₑₜₐ model, though it can be used in any log-bilinear model of node co-occurrence (e.g., Deepwalk, node2vec (Grover and Leskovec. node2vec: Scalable feature learning for networks. In Proceedings of the 22nd ACM SIGKDD international conference on Knowledge discovery and data mining, pages 855-864. ACM, 2016), LINE (Tang et al. Line: Large-scale information network embedding. In Proceedings of the 24th international conference on worldwide web, pages 1067-1077. International World Wide Web Conferences Steering Committee, 2015), and/or others).

Though GloVe models have input and output embedding vectors for each node, it is standard to use their sum for downstream applications of the embeddings. Thus, to implement MONET(GloVeₘₑₜₐ), in some implementations, the input and output topology embeddings U, V can be orthogonalized with the summed metadata embeddings Z:=X+Y. By linearity, this implies Z-orthogonal training of the summed topology representation W=U+V. The example MONET(GloVeₘₑₜₐ) loss is

$${ℒ}_{monet} ( U , V , {T}_{1} , {T}_{2} , a , b \vert C , M ) = \frac{1}{2} {\sum }_{i , j \leq n} {f}_{α} ( {C}_{ij} ) {( {a}_{i} + {b}_{j} + {U}_{i}^{T} {P}_{Z} {V}_{j} + {X}_{i}^{T} {Y}_{j} - log ( {C}_{ij} ) )}^{2} . \qquad ( 9 )$$

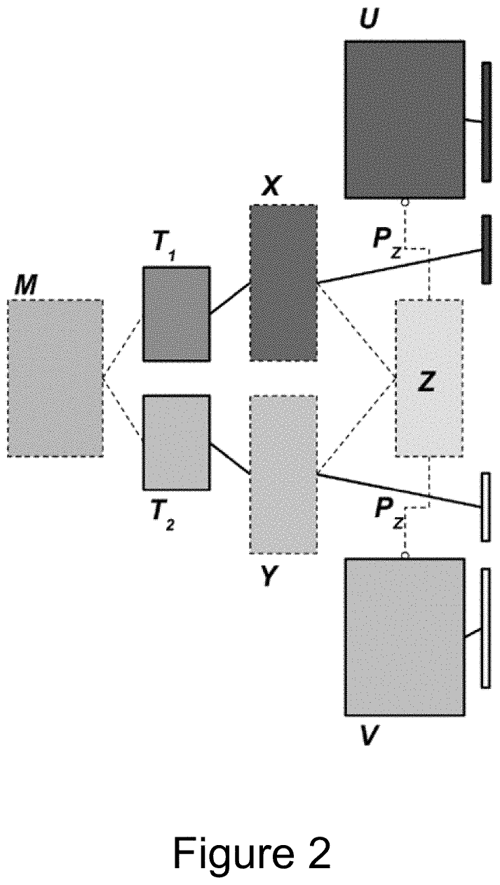

In some implementations, the neural network illustrated in FIG. 2 can be used to learn this model. In the illustrated network, dotted lines enclose un-trained weights and signify stopped gradient flow.

Example Metadata Parameter Interpretation: In [symbol] ₘₑₜₐ and [symbol] ₘₒₙₑₜ, the dot product Xᵢ^{T}Yⱼ=Mᵢ^{T}T₁T₂^{T}Mⱼ show that the matrix Σ_{T}:=T₁T₂^{T} contains all pairwise metadata dimension relationships. In other words, Σ_{T} gives the direction and magnitude of the raw metadata effect on log co-occurrence, and is therefore a way to measure the extent to which the model has captured metadata information. This interpretation is referred to in the example experiments contained in U.S. Provisional Patent Application No. 62/890,322.

### Example Devices and Systems

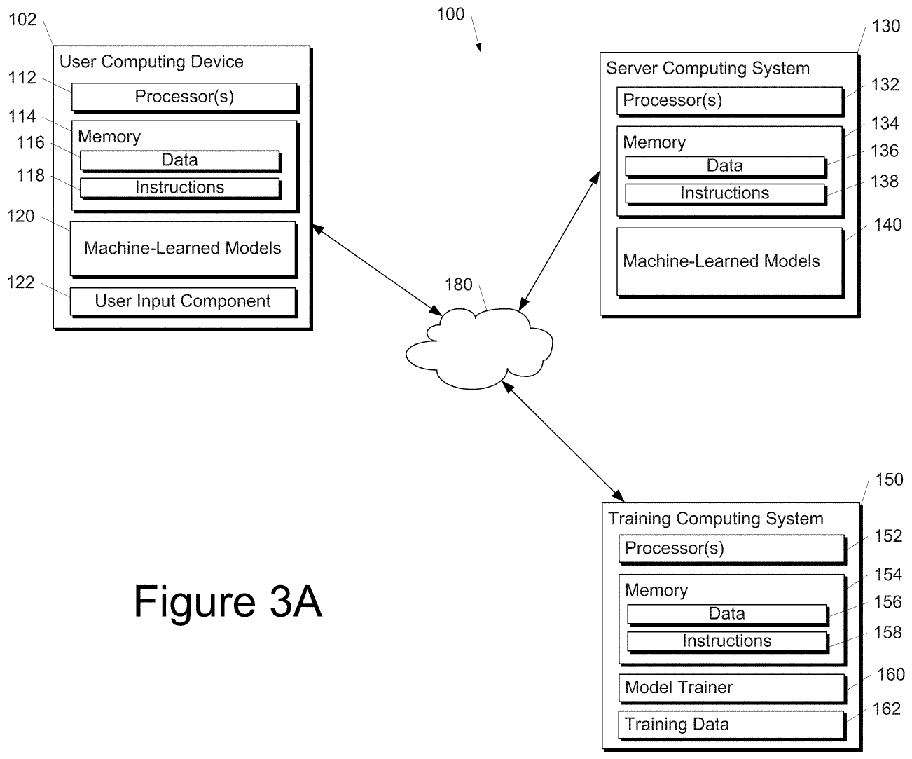

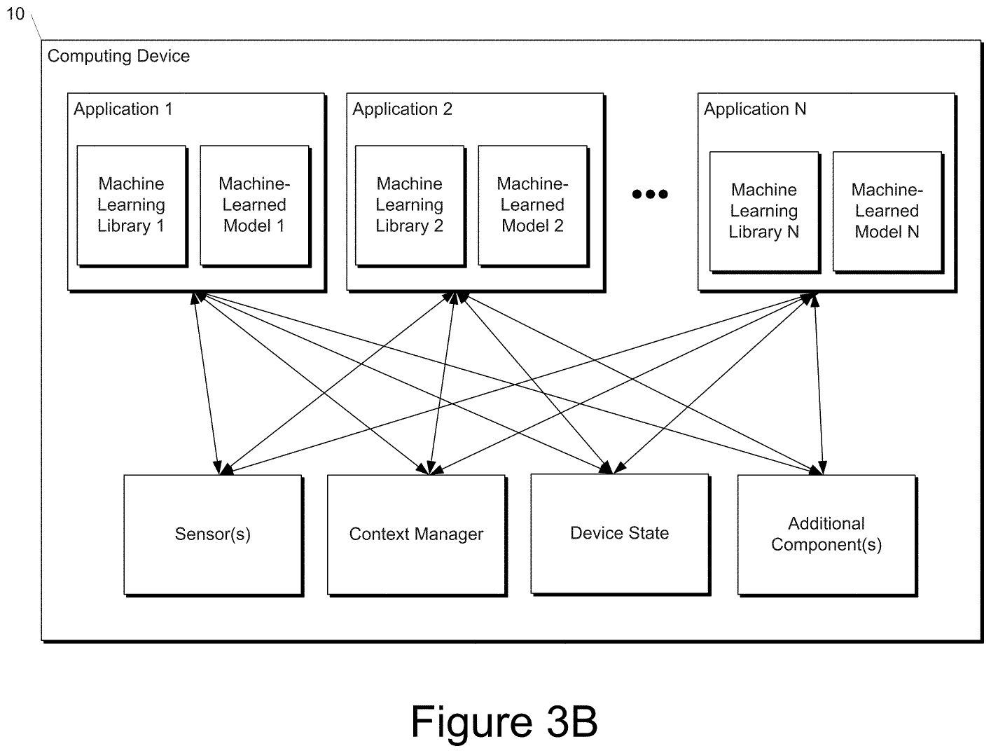

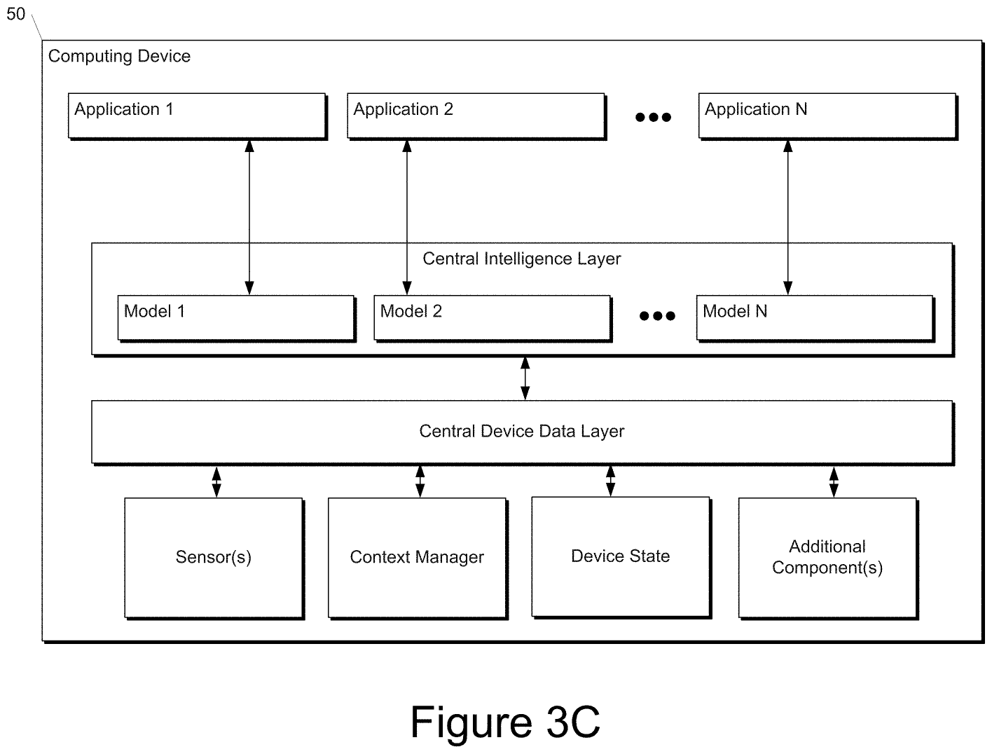

FIG. 3A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Specifically, example implementations of the present disclosure can train and/or employ a graph neural network. One example machine-learned model 120 is illustrated in FIG. 2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel graph embedding computation across multiple graphs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a graph embedding service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to Figures Specifically, example implementations of the present disclosure can train and/or employ a graph neural network. One example machine-learned model 140 is illustrated in FIG. 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, a set of training graphs. In some implementations, the model trainer 160 can perform unsupervised learning techniques. The model trainer 160 can perform any of the training techniques described herein, such as metadata-orthogonal training techniques.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

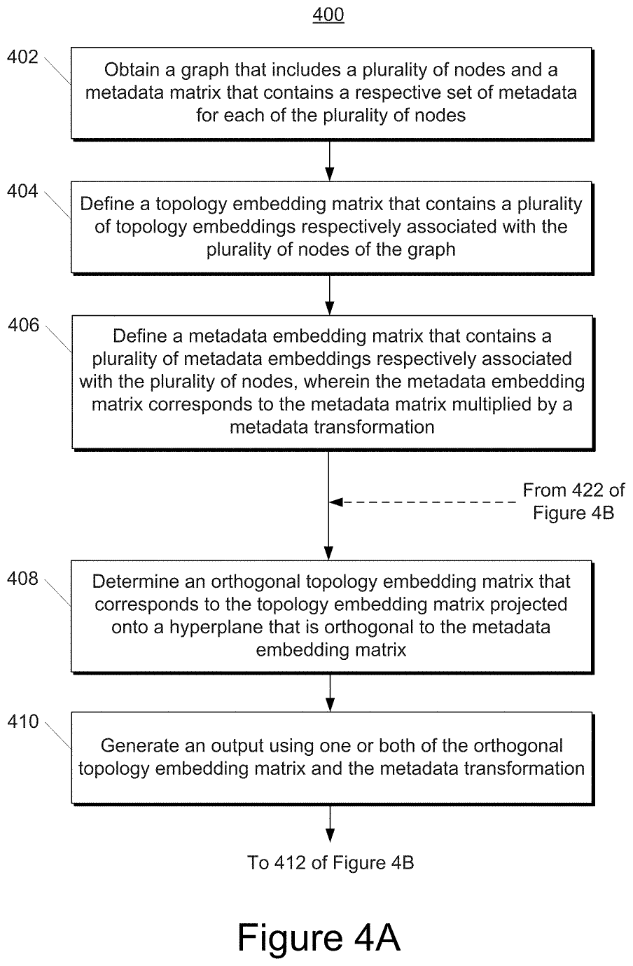

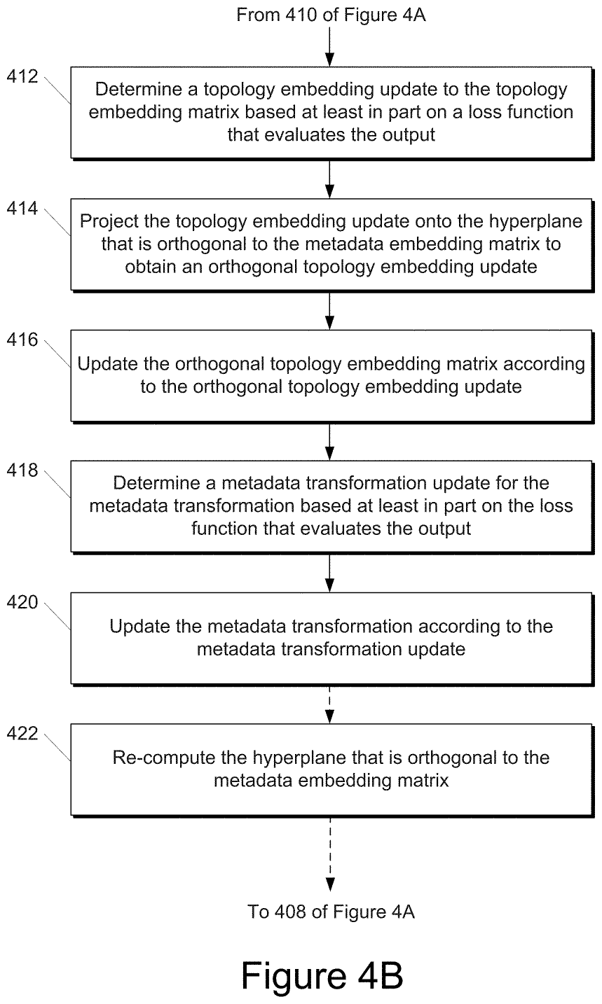

FIGS. 4A and 4B depict a flow chart diagram of an example method to perform according to example embodiments of the present disclosure. Although FIGS. 4A and 4B depict steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

Referring first to FIG. 4A, at 402, a computing system can obtain a graph that includes a plurality of nodes and obtain a metadata matrix that contains a respective set of metadata for each of the plurality of nodes.

At 404, the computing system can define a topology embedding matrix that contains a plurality of topology embeddings respectively associated with the plurality of nodes of the graph.

In some implementations, the topology embedding matrix can correspond to a sum of an input topology embedding matrix and an output topology embedding matrix. The input topology embedding matrix and the output topology embedding matrix can be equal to each other or non-equal to each other.

At 406, the computing system can define a metadata embedding matrix that contains a plurality of metadata embeddings respectively associated with the plurality of nodes. The metadata embedding matrix can correspond to the metadata matrix multiplied by a metadata transformation.

In some implementations, the metadata transformation can correspond to a sum of an input metadata transformation and an output metadata transformation. The input metadata transformation and the output metadata transformation can be equal to each other or non-equal to each other.

At 408, the computing system can determine an orthogonal topology embedding matrix that corresponds to the topology embedding matrix projected onto a hyperplane that is orthogonal to the metadata embedding matrix.

In some implementations, determining the orthogonal topology embedding matrix at 408 can include: performing singular value decomposition on the metadata embedding matrix to generate a set of left-singular vectors of the metadata embedding matrix; determining a projection based on the set of left-singular vectors; and projecting the topology embedding matrix according to the projection.

In some implementations, determining the projection based on the set of left-singular vectors can include subtracting, from an identity matrix, the set of left-singular vectors multiplied by a transpose of the set of left-singular vectors to obtain the projection.

In some implementations, determining the orthogonal topology embedding matrix at 408 can include: performing singular value decomposition on the metadata embedding matrix to generate a set of left-singular vectors of the metadata embedding matrix; and subtracting, from the topology embedding matrix, the set of left-singular vectors multiplied with a multiplicand produced through multiplication of a transpose of the set of left-singular vectors with the topology embedding matrix.

At 410, the computing system can generate an output using one or both of the orthogonal topology embedding matrix and the metadata transformation. For example, in some instances, the output can be the orthogonal topology embedding matrix and/or the metadata embedding matrix. In other implementations, a separate prediction, inference, classification, detection, cluster assignment, and/or the like can be produced as an output on the basis of orthogonal topology embedding matrix and/or the metadata transformation.

After 410, method 400 can proceed to 412 of FIG. 4B.

Referring now to FIG. 4B, at 412, the computing system can determine a topology embedding update to the topology embedding matrix based at least in part on a loss function that evaluates the output. As one example, the loss function can be a log-bilinear model of node co-occurrence.

At 414, the computing system can project the topology embedding update onto the hyperplane that is orthogonal to the metadata embedding matrix to obtain an orthogonal topology embedding update.

At 416, the computing system can update the orthogonal topology embedding matrix according to the orthogonal topology embedding update.

At 418, the computing system can determine a metadata transformation update for the metadata transformation based at least in part on the loss function that evaluates the output.

At 420, the computing system can update the metadata transformation according to the metadata transformation update.

Optionally, after 420, method 400 can proceed to 422. At 422, the computing system can re-compute the hyperplane that is orthogonal to the metadata embedding matrix.

After 422, method 400 can optionally return to 408 of FIG. 4A and perform one or more additional iterations of blocks 408-422. For example, iterations can be performed until one or more stopping criteria are met. The stopping criteria can be any number of different criteria including, as examples, a loop counter reaching a predefined maximum, an iteration over iteration change in parameter adjustments falling below a threshold, a gradient of the loss function being below a threshold value, and/or various other criteria.

After training according to the method 400, the produced graph neural network can be used to generate embeddings which can be used, among other purposes for node similarity analysis.

As one example, a computing system can compare a first topology embedding associated with a first node of a plurality of nodes to a second topology embedding associated with a second node of the plurality of nodes to determine a metadata-decorrelated similarity between the first node and the second node.

Likewise, the computing system can compare a first metadata embedding associated with a first node of the plurality of nodes to a second metadata embedding associated with a second node of the plurality of nodes to determine a topology-decorrelated similarity between the first node and the second node.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to de-bias a graph neural network, the method comprising:
obtaining, by one or more computing devices, a graph that comprises a plurality of nodes and a metadata matrix that contains a respective set of metadata for each of the plurality of nodes;
defining, by the one or more computing devices, a topology embedding matrix that contains a plurality of topology embeddings respectively associated with the plurality of nodes;
defining, by the one or more computing devices, a metadata embedding matrix that contains a plurality of metadata embeddings respectively associated with the plurality of nodes, wherein the metadata embedding matrix comprises the metadata matrix multiplied by a metadata transformation; and
for each of one or more training iterations:
determining, by the one or more computing devices, an orthogonal topology embedding matrix that comprises the topology embedding matrix projected onto a hyperplane that is orthogonal to the metadata embedding matrix;
generating, by the one or more computing devices, an output based on one or both of the orthogonal topology embedding matrix and the metadata transformation;
determining, by the one or more computing devices, a topology embedding update to the topology embedding matrix based at least in part on a loss function that evaluates the output;
projecting, by the one or more computing devices, the topology embedding update onto the hyperplane that is orthogonal to the metadata embedding matrix to obtain an orthogonal topology embedding update; and
updating, by the one or more computing devices, the orthogonal topology embedding matrix according to the orthogonal topology embedding update.

2. The computer-implemented method of claim 1, wherein the method further comprises, for each of the one or more training iterations:
determining, by the one or more computing devices, a metadata transformation update for the metadata transformation based at least in part on the loss function that evaluates the output;
updating, by the one or more computing devices, the metadata transformation according to the metadata transformation update; and
after updating the metadata transformation, re-computing the hyperplane that is orthogonal to the metadata embedding matrix for use in a next training iteration of the one or more training iterations.

3. The computer-implemented method of claim 1, wherein determining the orthogonal topology embedding matrix that comprises the topology embedding matrix projected onto the hyperplane that is orthogonal to the metadata embedding matrix comprises:
performing, by the one or more computing devices, singular value decomposition on the metadata embedding matrix to generate a set of left-singular vectors of the metadata embedding matrix;
determining, by one or more computing devices, a projection based on the set of left-singular vectors; and
projecting, by the one or more computing devices, the topology embedding matrix according to the projection.

4. The computer-implemented method of claim 1, wherein determining the projection based on the set of left-singular vectors comprises:
subtracting, by the one or more computing devices, from an identity matrix, the set of left-singular vectors multiplied by a transpose of the set of left-singular vectors to obtain the projection.

5. The computer-implemented method of claim 1, wherein determining the orthogonal topology embedding matrix that comprises the topology embedding matrix projected onto the hyperplane that is orthogonal to the metadata embedding matrix comprises:
performing, by the one or more computing devices, singular value decomposition on the metadata embedding matrix to generate a set of left-singular vectors of the metadata embedding matrix; and
subtracting, by the one or more computing devices, from the topology embedding matrix, the set of left-singular vectors multiplied with a multiplicand produced through multiplication of a transpose of the set of left-singular vectors with the topology embedding matrix.

6. The computer-implemented method of claim 1, wherein the loss function comprises a log-bilinear model of node co-occurrence.

7. The computer-implemented method of claim 1, wherein the topology embedding matrix comprises a sum of an input topology embedding matrix and an output topology embedding matrix.

8. The computer-implemented method of claim 1, wherein the metadata transformation comprises a sum of an input metadata transformation and an output metadata transformation.

9. The computer-implemented method of claim 1, wherein the method further comprises:
after the one or more training iterations, comparing, by the one or more computing devices, a first topology embedding associated with a first node of the plurality of nodes to a second topology embedding associated with a second node of the plurality of nodes to determine a metadata-decorrelated similarity between the first node and the second node.

10. The computer-implemented method of claim 1, wherein the method further comprises:
after the one or more training iterations, comparing, by the one or more computing devices, a first metadata embedding associated with a first node of the plurality of nodes to a second metadata embedding associated with a second node of the plurality of nodes to determine a topology-decorrelated similarity between the first node and the second node.

11. The computer-implemented method of claim 1, wherein:
the plurality of nodes respectively correspond to biological or chemical structures; and
the method further comprises performing an automated discovery search based on the one or both of plurality of topology embeddings or the plurality of metadata embeddings.

12. A computing system, comprising:
one or more processors;
a graph neural network trained by performance of operations, the operations comprising:
obtaining a graph that comprises a plurality of nodes and a metadata matrix that contains a respective set of metadata for each of the plurality of nodes;
defining a topology embedding matrix that contains a plurality of topology embeddings respectively associated with the plurality of nodes;
defining a metadata embedding matrix that contains a plurality of metadata embeddings respectively associated with the plurality of nodes, wherein the metadata embedding matrix comprises the metadata matrix multiplied by a metadata transformation; and
for each of one or more training iterations:
determining an orthogonal topology embedding matrix that comprises the topology embedding matrix projected onto a hyperplane that is orthogonal to the metadata embedding matrix;
generating an output based on one or both of the orthogonal topology embedding matrix and the metadata transformation;
determining a topology embedding update to the topology embedding matrix based at least in part on a loss function that evaluates the output;
projecting the topology embedding update onto the hyperplane that is orthogonal to the metadata embedding matrix to obtain an orthogonal topology embedding update; and
updating the orthogonal topology embedding matrix according to the orthogonal topology embedding update; and
one or more non-transitory computer-readable media that collectively store instructions that, when executed by one or more processors, cause the computing system to run the graph neural network to generate a set of additional embeddings for an additional graph.

13. The computing system of claim 12, wherein the set of additional embeddings comprise a set of additional topology embeddings and the instructions cause the computing system to:
compare a first additional topology embedding associated with a first node of the additional graph to a second topology embedding associated with a second node of the additional graph to determine a metadata-decorrelated similarity between the first node and the second node.

14. The computing system of claim 12, wherein the set of additional embeddings comprise a set of additional metadata embeddings and the instructions cause the computing system to:
compare a first additional metadata embedding associated with a first node of the additional graph to a second metadata embedding associated with a second node of the additional graph to determine a topology-decorrelated similarity between the first node and the second node.

15. The computing system of claim 12, wherein:
the additional graph comprises a plurality of nodes that respectively correspond to biological or chemical structures; and
the method further comprises performing an automated discovery search based on the additional embeddings.

16. One or more non-transitory computer-readable media that collectively store instructions that, when executed by one or more computing devices, cause the one or more computing devices to perform operations, the operations comprising:
obtaining a graph that comprises a plurality of nodes and a respective set of metadata for each of the plurality of nodes;
defining a plurality of topology embeddings respectively associated with the plurality of nodes;
defining a plurality of metadata embeddings respectively associated with the plurality of nodes, wherein the plurality of metadata embeddings comprises the respective sets of metadata multiplied by a metadata transformation; and
for each of one or more training iterations:
determining a plurality of orthogonal topology embeddings that comprises the plurality of topology embeddings projected onto a hyperplane that is orthogonal to the plurality of metadata embeddings;
generating an output using one or both of the plurality of orthogonal topology embeddings and the metadata transformation;
determining a plurality of topology embedding updates to the plurality of topology embeddings based at least in part on a loss function that evaluates the output;
projecting the plurality of topology embedding updates onto the hyperplane that is orthogonal to the plurality of metadata embeddings to obtain a plurality of orthogonal topology embedding updates; and
updating the plurality of orthogonal topology embeddings according to the plurality of orthogonal topology embedding updates.

17. The one or more non-transitory computer-readable media of claim 16, wherein the operations further comprise, for each of the one or more training iterations:
determining, by the one or more computing devices, a metadata transformation update for the metadata transformation based at least in part on the loss function that evaluates the output;
updating, by the one or more computing devices, the metadata transformation according to the metadata transformation update; and
after updating the metadata transformation, re-computing the hyperplane that is orthogonal to the metadata embedding matrix for use in a next training iteration of the one or more training iterations.

18. The one or more non-transitory computer-readable media of claim 16, wherein determining the orthogonal topology embedding matrix that comprises the topology embedding matrix projected onto the hyperplane that is orthogonal to the metadata embedding matrix comprises:
performing, by the one or more computing devices, singular value decomposition on the metadata embedding matrix to generate a set of left-singular vectors of the metadata embedding matrix;
determining, by one or more computing devices, a projection based on the set of left-singular vectors; and
projecting, by the one or more computing devices, the topology embedding matrix according to the projection.

19. The one or more non-transitory computer-readable media of claim 16, wherein determining the projection based on the set of left-singular vectors comprises:
subtracting, by the one or more computing devices, from an identity matrix, the set of left-singular vectors multiplied by a transpose of the set of left-singular vectors to obtain the projection.

20. The one or more non-transitory computer-readable media of claim 16, wherein determining the orthogonal topology embedding matrix that comprises the topology embedding matrix projected onto the hyperplane that is orthogonal to the metadata embedding matrix comprises:
performing, by the one or more computing devices, singular value decomposition on the metadata embedding matrix to generate a set of left-singular vectors of the metadata embedding matrix; and
subtracting, by the one or more computing devices, from the topology embedding matrix, the set of left-singular vectors multiplied with a multiplicand produced through multiplication of a transpose of the set of left-singular vectors with the topology embedding matrix.
